(19) United States
(12) Patent Application Publication
(10) Pub. No.: US 2016/0312156 A1
(43) Pub. Date: Oct. 27, 2016

(54) STABLE LIQUID COMPOSITIONS CONTAINING ENZYMES AND PEROXIDES

(71) Applicant: ARKEMA INC., King of Prussia, PA (US)

(72) Inventors: Pan PAN, King of Prussia, PA (US); Michael B. ABRAMS, Bala Cynwyd, PA (US); Michael ROBBINS, Paoli, PA (US); John M. BARNES, Wilmington, DE (US); Shui-Ping ZHU, Gurnee, IL (US); Xue WANG, Sugar Land, TX (US)

(21) Appl. No.: 15/105,008

(22) PCT Filed: Dec. 18, 2014
(86) PCT No.: PCT/US14/71016

§ 371 Date: Jun. 16, 2016

Related U.S. Application Data
(60) Provisional application No. 61/917,477, filed on Dec. 18, 2013.

(51) Int. Cl. C11D 3/386; C11D 3/39

(52) U.S. Cl. CPC C11D 3/38663; C11D 3/3937; C11D 3/3947

(57) ABSTRACT

A stable, aqueous, liquid composition comprises both an enzyme and a peroxide or peroxide source. The composition contains a compatibilizer package having at least one compound chosen from enzyme stabilizers and peroxide stabilizers. The compatibilizer package maintains the activity of the enzyme and the concentration of the peroxide. A composition comprising peroxide or a peroxide source and a compatibilizer package is also disclosed.

### FIELD OF THE INVENTION

The present invention relates to stable liquid compositions containing enzymes and peroxides.

### BACKGROUND OF THE INVENTION

In the field of cleaning compositions, enzymes and peroxides are known to be efficient and effective cleaning agents. Enzymes and peroxides serve specific functions within cleaning compositions.

Enzymes are proteins that selectively catalyze reactions, such as the hydrolysis or decomposition of proteins, fats, and starches, and thus are efficient in removing stains and organic materials.

Peroxides, such as hydrogen peroxide, are strong oxidizers that react with many chemical species and are widely used in cleaning processes for removing many types of soils and stains.

It has long been desirable to combine enzymes and peroxides in a single cleaning solution to gain the enhanced cleaning performance that would result from using both types of cleaning agents. Combinations of enzymes and peroxides have promising prospects and should present dramatically enhanced cleaning performance due to integration of different mechanisms from the two agents. A liquid composition containing both enzymes and peroxides with stable activity has been long desired by the market, but has not been developed.

Due to their chemical properties, enzymes and peroxides are not compatible when mixed with each other in the liquid phase because enzymes and peroxides decompose each other. Prior attempts to combine enzymes and peroxides have included the use of a liquid composition with the enzyme and peroxide in two separate packages, the use of an enzyme and peroxide in separate phases (e.g., aqueous enzymes with suspended peroxide particles), or in a single, but unstable, liquid phase where the enzyme and/or the peroxide are unstable.

U.S. Patent Application No. 2002/0082181 finds that the enzyme Savinase® is not stable in liquid cleaning compositions with hydrogen peroxide, and discloses the use of enzyme crystal or cross-linked enzyme crystal together with hydrogen peroxide.

U.S. Pat. No. 5,275,753 uses special means to apply both enzyme and a solid bleaching agent together in a liquid composition. The solid bleaching agent, such as sodium perborate or percarbonate, is suspended in the form of small particles in the liquid composition. Magnesium salts are used to stabilize the enzyme.

U.S. Pat. No. 5,698,507 discloses the use of gel formulations and acid stable enzymes to create a composition containing both an enzyme and peroxide.

Compositions comprising either an enzyme or peroxides commonly use a stabilizer to preserve the activity of the enzyme or maintain the concentration of the peroxide over time. For example, hydrolytic molecules, including diols and polyols, are known to stabilize enzymes. Other known enzyme stabilizers include, for example, organic boron compounds, such as 4-formylphenyl boronic acid and 4-methoxyphenyl boronic acid.

Similarly, peroxide stabilizers are also known in the art. For example, common peroxide stabilizers include stannates and chelating agents, such as ethylenediaminetetraacetic acid (EDTA).

U.S. Patent Application Publication No. 2010/240562 proposed an enzyme stabilization system containing organic or inorganic acids, amines, and a solvent. The solvent could be 1-20% monoalcohol or polyols, such as glycerol and ethylene glycol.

U.S. Patent Application Publication No. 2011/290281 describes a cleaning composition, which contains enzymes, an organic solvent, boric acid, and Ca or Mg ions. The solvent could be selected from mono- or polyhydric alcohols, alkanolamines, or glycol ethers, and is present in an amount ranging from 5-80% of the total weight.

International Patent Publication WO2010/064086 describes a laundry composition containing enzymes, polymers and enzyme stabilizers, including sugar alcohols and other polyols.

U.S. Patent Application Publication No. 2011/0110912 discloses agents for stabilizing glucose oxidase activity in aqueous solutions, wherein the agents may include gluconate, metabisulfite, ascorbate, glucose, and tetra-potassium pyrophosphate. However, these stabilizing agents are only disclosed for use in enzyme-containing solutions and not solutions containing both enzymes and peroxides.

Other attempts have been made to combine enzymes and peroxides in a single composition. For example, U.S. Patent Application Publication No. 2011/237487, U.S. Patent Application Publication No. 2012/0289447, and U.S. Pat. No. 4,470,919 generically disclose the use of both an enzyme and a peroxide, but they do not disclose stable liquid compositions containing the enzymes and peroxides. Japanese Patent No. 2007-131785 and U.S. Patent Application Publication No. 2011/023748 disclose the use of certain specialized enzymes with hydrogen peroxide, but do not disclose stable liquid compositions.

U.S. Patent Application Publication No. 2001/0000509 discloses a detergent composition with excellent enzyme stability in alpha-keratin hydrolysis. However, enzyme stability was shown for only 20 minutes at 20° C. in a washing solution, and the patent does not disclose stable liquid compositions.

U.S. Pat. No. 5,880,252 discloses pyrrolidonyl-containing polyesters and polyamides as stabilizing agents, but does not disclose compatibilization of both peroxides and enzymes.

Stabilization of enzymes in peroxide solutions is extremely challenging due to reactivity of both enzymes and peroxides. So far no available technique has been disclosed to prepare a liquid composition of enzymes and peroxides with stable activity.

### SUMMARY OF THE INVENTION

The present invention relates to stable, aqueous, liquid compositions comprising a compatibilizer package.

A first aspect of the present invention relates to an aqueous, liquid composition comprising at least one enzyme, at least one peroxide or peroxide source, and a compatibilizer package. The compatibilizer package comprises at least one compound chosen from enzyme stabilizers and peroxide stabilizers, and the compatibilizer package stabilizes the at least one enzyme and the at least one peroxide or peroxide source.

Another aspect of the present invention relates to cleaning compositions comprising an aqueous, liquid composition comprising at least one enzyme, at least one peroxide or peroxide source, and a compatibilizer package.

Yet another aspect of the present invention relates to an aqueous, liquid composition comprising at least one peroxide or peroxide source and a compatibilizer package. The compatibilizer package contains at least one compound chosen from enzyme stabilizers and peroxide stabilizers. The at least one peroxide or peroxide source is present in an amount of 10% by weight or more based on the total weight of the composition.

### BRIEF DESCRIPTION OF THE DRAWINGS

FIG. 1 is a schematic diagram of the catalytic triad of a serine protease.

FIG. 2 is a schematic diagram showing hydrogen binding between the catalytic triad of a serine protease and ligands.

### DETAILED DESCRIPTION OF THE INVENTION

One aspect of the present disclosure relates to aqueous, liquid compositions comprising at least one enzyme, at least one peroxide or peroxide source, and a compatibilizer package, wherein the enzyme and peroxide are present in the liquid phase.

As used herein, the term “aqueous” means a liquid composition comprising water in an amount comprising at least 20% by weight of the total composition

As used herein, the term “peroxide” refers to a compound having a peroxide group or an acidic —OOH group. Thus, the term “peroxide” includes both peroxides and peroxy acids.

As used herein, the phrase “peroxide source” means a compound that forms a peroxide group or peroxide anion when dissolved or dispersed in water. Peroxide sources may include, for example, perborates, percarbonates, or inorganic perhydrate salts, which form peroxides when dissolved in water.

As used herein, the phrase “compatibilizer package” refers to a collection of at least one compound that does not accelerate the rate of peroxide and enzyme decomposition in a liquid composition containing both an enzyme and a peroxide when compared to a control composition that does not contain a compatibilizer package. In accordance with at least one embodiment, the compatibilizer package slows the rate of decomposition for at least one of enzymes and peroxides, e.g., a compatibilizer package in which, compared to a control without the compatibilizer package, the enzyme decomposes at a slower rate and the peroxide decomposes at the same rate.

The compositions may comprise enzymes known for use in cleaning or detergent compositions. For example, the at least one enzyme may be chosen from oxidoreductases (EC1.1, 1.10, and 1.11), proteases (EC3.4), amylases (EC3.2), lipases (EC3.1), lyases (EC4.1 and 4.2), disinfectant enzymes, and combinations thereof, as wild type or mutant derivatives. In at least one embodiment, the at least one enzyme may be chosen from chitinase, chitosanase, N-acetylmuramidase, N-acetylglucoasiminidase, actinase, zymolyase, kitalase, mutanolysin, achromopeptidase, beta-1,3-glucanase, cellulases, pectinases, and combinations thereof. Other enzymes may also be used.

In accordance with at least one embodiment, the composition may comprise a plurality of enzymes. For example, the composition may comprise enzymes chosen from more than one class of enzyme to catalyze the decomposition of several different types of soil. For example, the composition may comprise a protease, a lipase, and a disinfectant enzyme. The composition may also contain more than one enzyme from each class of enzyme, such as, for example, more than one lipase.

Modified enzymes may also be used in accordance with embodiments of the present disclosure. In at least one embodiment, the composition may contain structurally modified and/or immobilized enzymes. For example, the composition may comprise enzyme crystals or cross-linked enzyme crystals.

In accordance with at least one embodiment, the composition may comprise at least one enzyme in an amount ranging from about 1 ppm to about 20% by weight of the total composition. In at least one embodiment, the at least one enzyme may be present in an amount ranging from about 5 ppm to about 15%, or from about 10 ppm to about 10% by weight of the total composition.

The compositions according to the present disclosure may contain at least one peroxide or peroxide source. In at least one embodiment, the composition may comprise a peroxide or peroxide source chosen from organic and inorganic peroxides, such as hydrogen peroxide, peroxy acids (e.g., peracetic acid and higher alkyl peracids), alkylhydroperoxides, dialkylperoxides, inorganic perhydrate salts (e.g., sodium salts of perborate, including mono- or tetrahydrate perborate salts), percarbonates, persulfates, perphosphates, persilicates, and combinations thereof.

The compositions may comprise at least one peroxide, peroxide source, or a combination of peroxides and peroxide sources. Examples of peroxide sources, include, but are not limited to urea-hydrogen peroxide, inorganic perhydrate salts, percarbonates, persulfates, perphosphates, persilicates and mixtures thereof,

According to at least one embodiment, the composition comprises at least one peroxide or peroxide source in an amount ranging from about 1 ppm to about 50% by weight of the total composition. In at least one embodiment, the at least one peroxide or peroxide source is present in an amount ranging from about 5 ppm to about 15%, or from about 10 ppm to about 10% by weight of the total composition. According to at least one embodiment, the at least one peroxide or peroxide source is present in an amount up to 50%, up to about 40%, up to about 30%, up to about 20%, up to about 15%, or up to about 10% by weight of the total composition.

In accordance with at least one embodiment, the compatibilizer package comprises at least one compound chosen from enzyme stabilizers and peroxide stabilizers, wherein the enzyme stabilizer or peroxide stabilizer are chosen such that they do not increase the rate of peroxide decomposition and rate of enzyme activity loss. In at least one embodiment, the compatibilizer package may contain at least one enzyme stabilizer and at least one peroxide stabilizer.

Among the chemicals that are known to stabilize enzymes or peroxides, the present inventors have discovered that it is not possible to predict which stabilizers are suitable for use in the compatibilizer package in accordance with the present disclosure. For example, the inventors have discovered that some stabilizers known for stabilizing either enzymes or peroxides alone in solution accelerate the decomposition of the enzymes or peroxides when used together in solution. Organic boron compounds, such as, for example, 4-formylphenyl boronic acid and 4-methoxyphenyl boronic acid are known to be effective enzyme stabilizers in compositions which do not contain peroxide. However, those organic boron compounds fail to stabilize enzymes when peroxide is present.

The inventors have also discovered that it is not possible to assume the stabilizing properties based on similar materials. For example, 100 mM sodium sulfate acts as an enzyme stabilizer in a liquid composition comprising both an enzyme and a peroxide. 100 mM lithium sulfate, however, destabilizes the liquid composition and accelerates the decomposition of the enzyme in the solution.

In accordance with at least one embodiment, the compatibilizer package may comprise at least one enzyme stabilizer chosen from diols, polyols, short carbon chain fatty acids, amines, alkanolamines, and compounds comprising calcium, magnesium, sodium, potassium, lithium, tin, organic ammonium ions, and combinations thereof.

According to at least one embodiment, the at least one enzyme stabilizer is chosen from compounds comprising metal ions chosen from calcium, magnesium, sodium, potassium, lithium, aluminum, and tin. Examples of compounds comprising metal ions include sulfates and nitrates of calcium, magnesium, sodium, potassium, lithium, and tin. Specific examples include, but are not limited to, calcium nitrate, lithium sulfate, and potassium sulfate.

According to at least one embodiment, the composition may comprise at least one enzyme stabilizer chosen from hydrolytic molecules. For example, the enzyme stabilizer may be chosen from diols and polyols.

In at least one embodiment, the composition comprises at least one polyol containing 2 to 16 hydroxy groups, such as, for example, from 2 to 12 hydroxy groups, from 2 to 10 hydroxy groups, or from 2 to 8 hydroxy groups. In at least one embodiment, the at least one polyol contains 4, 5, or 6 hydroxy groups.

In at least one embodiment, the at least one polyol contains 2 to 16 carbon atoms, such as, for example, from 2 to 12 carbon atoms, from 2 to 10 carbon atoms, or from 2 to 8 carbon atoms. According to at least one embodiment, the at least one polyol contains 4, 5, or 6 carbon atoms.

According to at least one embodiment, the composition contains at least one diol containing 2 to 14 carbon atoms, such as, for example, from 2 to 12 carbon atoms, from 2 to 10 carbon atoms, or from 2 to 8 carbon atoms.

Examples of diols and polyols that may be used include, but are not limited to, ethylene glycol, erythritol, xylitol, galactitol, maltitol, inositol, sorbitol, mannitol, and combinations thereof.

In accordance with at least one embodiment, the at least one enzyme stabilizer may comprise a ligand capable of binding to the active site of the enzyme. Without wishing to be bound by theory, it is believed that a ligand can bind to an enzyme through hydrogen bonding to stabilize the activity of the enzyme. The ligand may comprise, for example, a compound comprising a central atom and two or more oxygen or two or more halogen atoms bonded to the central atom.

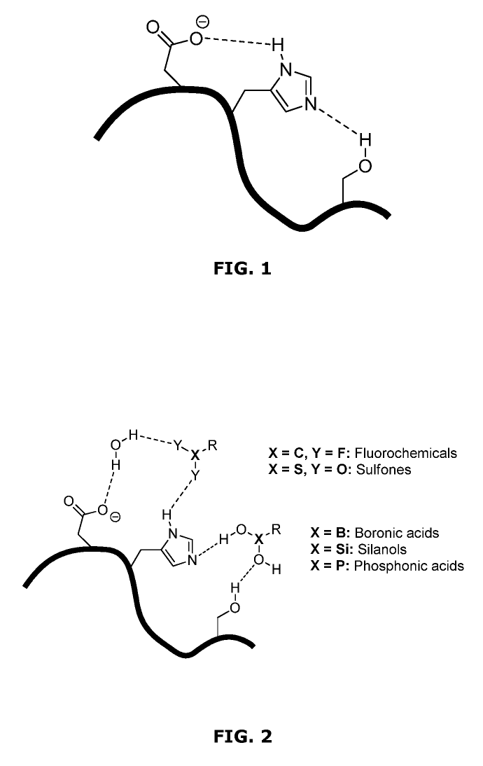

For example, proteases are one of the most commonly used class of enzymes in cleaning products. One exemplary protease belongs to the serine protease family, which catalyzes the hydrolysis of proteins through a triad in the active site, as shown in FIG. 1. In the serine proteases, the triad is formed of three adjacent amino acids, aspartic acid, histidine, and serine. The serine hydroxyl group attacks the amide group of peptides and leads to hydrolysis after a few steps of proton transfer.

The ligand may be a compound of Formula 1:

XY₂Rₙ (Formula 1)

wherein X is a boron, carbon, nitrogen, silicon, phosphorus, or sulfur atom, and Y is a hydroxyl group or an oxygen or halogen atom. Depending on the valency of X, n range from 1 to 4. The R groups are independently chosen from hydroxyl groups or alkyl groups containing 1 to 12 carbon atoms, aryl groups containing 1 to 12 carbon atoms, hydrogen atoms, oxygen atoms, or halogen atoms. The alkyl or aryl groups may be further functionalized with hydroxyl, carbonyl, carboxyl, ether, ester, nitro, quaternary ammonium, or sulfonate groups, or may be attached to another central atom with the structure of formula 1. When n is greater than 1, R may form a ring structure including the central atom, X.

FIG. 2 shows how the ligands can hydrogen bond to the serine protease. For example, when Y is chosen from oxygen atoms or halogen atoms, the oxygen atoms or halogen atoms can hydrogen bond with the aspartic acid and histidine of the catalytic triad. Similarly, when Y is a hydroxyl group, the ligand can hydrogen bond to the histidine and serine of the catalytic triad.

In at least one embodiment, the ligands may comprise a central atom, X, chosen from carbon or sulfur, Y may be chosen from oxygen atoms or halogen atoms, and the R groups as defined above. For example, the ligand may comprise a fluorochemical, such as trifluoroacetic acid, dichloroacetic acid, 2-chloro-2-fluorobutane, 2,2,2-trifluoroacetophenone and hexafluoroacetone; or a sulfone, such as dimethyl sulfone or sulfolane.

In other embodiments, the ligands may comprise a central atom, X, chosen from boron, silicon, or phosphorus, Y comprises hydroxyl groups, and R is as defined above. For example, the ligand may be chosen from boronic acids, such as 4-formylphenylboronic acid; or a silanol, such as diphenylsilanediol; or a phosphonic acid, such as methylphosphonic acid and phenylphosphonic acid.

In accordance with at least one embodiment, the at least one enzyme stabilizer may comprise a polymer or copolymer, collectively referred to herein as polymers. Without wishing to be bound by theory, it is believed that polymers and copolymers can stabilize the structure of enzymes through electrostatic forces or hydrogen bonding, interacting with or covering the surface of the enzyme to prevent oxidation or degradation of the enzyme. By protecting the surface of the enzymes, the polymers may shield the enzymes from the oxidative effects of peroxide in the solution. Enzymes can contain both positively and negatively charged amino acids. Cationic, anionic, and zwitterionic polymers can stabilize enzymes by interacting with the charged amino acids. The polymers may also stabilize the enzymes through hydrogen bonding. Therefore, neutral polymers may also act as enzyme stabilizers. The polymer may be selected based on the nature of the enzyme being stabilized. For example, cationic polymers may be used to stabilize enzymes having a negative net charge on the surface. The polymer may also be selected based on other components present in the composition. For example, when anionic surfactants are present, an anionic, nonionic, or zwitterionic polymer may be used to compatibilize the liquid composition. The polymer may also be selected based on other properties. For example, in some compositions, anionic polymers may improve the physical appearance of the composition by providing less haziness or preventing crystallization.

Examples of polymer enzyme stabilizers include, but are not limited to, polyacrylates, polymethacrylates, polyethoxylates, polyacrylamide, polyquaterniums, and polybetaines. In at least one embodiment, the polymer is chosen from polyquaternium-11, polyquaternium-16, polyDADMAC, poly (acrylamido-N-propyltrimethylammonium chloride) (polyATPAC), polyoxypropylene-polyoxyethylene block copolymers (e.g., Pluronic® 25R2), polyethylene glycols (e.g., PEG-40 stearate, PEG 8000), polyacrylates (e.g., Acusol® 425N), and poly(3-(3-acrylamidopropyldimethylammonio)propionate) (polyAMDAP). In at least one embodiment, the polymer is a cationic polymer, such as, for example, a polyquaternium, such as polyDADMAC and Luviquat® PQ 11.

In accordance with at least one embodiment, the at least one enzyme stabilizer may comprise a carboxylic acid or carboxylate salt. In at least one embodiment, the carboxylic acid or carboxylate salt may comprise a short aliphatic chain of 12 carbon atoms or less or have an aromatic group, such as a phenyl group or hydroxyphenyl group. In at least one embodiment, the enzyme stabilizer is chosen from acetic acid, benzoic acid, picolinic acid, salicylic acid, or sodium salicylate

The compositions may also contain other enzyme stabilizers. In at least one embodiment, the composition may contain an enzyme stabilizer chosen from amines, akanolamines, ammonium ions, and combinations thereof.

In at least one embodiment, the composition may contain at least one enzyme stabilizer in an amount ranging from about 10 ppm to about 30% by weight of the total composition. In at least one embodiment, the at least one enzyme stabilizer is present in an amount ranging from about 0.05% to about 25%, such as, from about 0.1% to about 25%, or from about 0.1% to about 15% by weight of the total composition.

In accordance with at least one embodiment, the compatibilizer package may comprise at least one peroxide stabilizer. Examples of peroxide stabilizers include, but are not limited to, stannates, phosphates, pyrophosphates, carboxylates, organic chelating agents, and combinations thereof. Suitable stabilizers may include stannates, for example, such as stannic chloride, stannic oxide, stannic bromide, stannic chromate, stannic iodide, stannic sulfide, tin dichloride bis(2,4-pentanedionate), tin phthalocyanine dichloride, tin acetate, and the like. The compatibilizer package may also comprise additional stabilizers, such as aromatic chelating agents or aromatic radical scavengers, known to one of ordinary skill in the art. Specific examples of peroxide stabilizers that may be used in accordance with the present disclosure include, but are not limited to, sodium stannate, potassium stannate, ethylenediaminetetraacetic acid (EDTA), amine-substituted organophosphonic acids or their salts, butylated hydroxytoluene (BHT), butylated hydroxyanisole (BHA), phenols, and combinations thereof.

In at least one embodiment, the composition may contain at least one peroxide stabilizer in an amount ranging from about 10 ppm to about 30% by weight of the total composition. In at least one embodiment, the at least one peroxide stabilizer is present in an amount ranging from about 0.05% to about 25%, such as, from about 0.1% to about 25%, or from about 0.1% to about 15% by weight of the total composition.

The compatibilizer package may comprise more than one enzyme stabilizer and/or more than one peroxide stabilizer. For example, the compatibilizer package may comprise a plurality of enzyme stabilizers and a plurality of peroxide stabilizers.

The stabilizers contained in the compatibilizer package may reduce the decomposition rate of the enzyme and/or peroxide present in the composition. The performance of the compatibilizer package may be determined by the activity of the enzyme or the concentration of the peroxide in the composition.

According to at least one embodiment, the compatibilizer package maintains at least 10% of the enzyme activity (i.e., the residual enzyme activity) after 4 weeks at 37° C. at a pH of 7. In at least one embodiment, at least 10%, at least 15%, at least 20%, at least 25%, at least 30%, at least 35%, or at least 40% of the enzyme activity remains after 4 weeks at 37° C. at a pH of 7.

In accordance with at least one embodiment, the compatibilizer package maintains at least 75% of the peroxide content (i.e., the residual peroxide content) after 4 weeks at 37° C. at a pH of 7. In at least one embodiment, at least 85%, at least 90%, at least 95%, at least 98%, or at least 99% of the peroxide remains after 4 weeks at 37° C. at a pH of 7.

In accordance with at least one embodiment, the liquid composition may be a homogeneous, single-phase solution.

In at least one embodiment, the liquid composition may comprise a solid phase. For example, a portion of certain components of the liquid composition may precipitate out of solution or the liquid composition may comprise a solid phase component, such as, for example, a suspended peroxide. However, in these liquid compositions comprising a solid content, the liquid component comprises at least a portion of the at least one enzyme and the at least one peroxide or peroxide source in the liquid phase. In at least one embodiment, at least 50% of the enzyme and peroxide content is in the liquid phase, such as, for example, at least 75%, at least 90%, or at least 95% of the total amount of enzyme and peroxide in the composition.

In accordance with at least one embodiment, the compositions may comprise water in an amount of at least 20% by weight of the total composition. In at least one embodiment, water may be present in the composition in an amount of at least 35%, at least 50%, at least 75%, or at least 80% by weight of the total composition.

The liquid compositions of the present disclosure may be formulated as cleaning solutions. Exemplary cleaning solutions include, but are not limited to, laundry detergent, fabric softener, laundry prespotter (spray or gel or pen), auxiliary bleach (liquid or paste), hand dish detergent, automatic dishwasher detergent (gel or paste or suspension), carpet prespotter, carpet cleaner, hard surface cleaner (spray or concentrated/dilutable), toilet bowl cleaner, hand detergent, general basin/tub/tile foam cleaner, abrasive surface cleaner, or disinfection cleaning solutions.

Compositions according to the present disclosure may also be formulated for use in the following applications:
Pulp and paper: bleaching, brightening, and delignification in mechanical and chemical pulping, and deinking during paper recycling;
Personal care: antiseptic applications, hair bleaching and coloring, tooth whitening and oral care;
Chemical processes: general oxidation reactions including but not limited to epoxidation, hydroxylation, bromine reactivation, organic peroxide production, amine oxidation, processes for chemical or pharmaceutical synthesis or manufacture, as well as decolorization;
Textile or fiber bleaching;
Environmental: water treatment, wastewater or storm water treatment, including but not limited to pollutant degradation and decolorization, and wastewater or storm water odor reduction or elimination;
General broad-spectrum disinfection and sanitization, mold/mildew, spore, virus, fungus removers;
Defense: chemical or biological warfare agent degradation;
Improved delignification for increased cellulosic ethanol production or for the production of useful organic chemicals from biomass; and
Desulfurization of diesel fuel, gasoline, kerosene, biodiesel, coal, or natural gas.

Another aspect of the present disclosure relates to liquid compositions comprising at least one peroxide or peroxide source and a compatibilizer package. The compatibilizer package comprises at least one enzyme stabilizer and at least one peroxide stabilizer. Such formulations may be used as concentrated solutions which may be diluted prior to the desired final formulation.

In at least one embodiment, the liquid composition may comprise the at least one hydrogen peroxide or peroxide source in an amount comprising at least 10% by weight of the total composition. In at least one embodiment, the concentration liquid composition may comprise the at least one peroxide or peroxide source in an amount of at least 30%, at least 40%, or at least 50% by weight of the total composition.

According to at least one embodiment, the concentrated composition may further comprise at least one enzyme.

In accordance with at least one embodiment, at least 75% of the peroxide or peroxide source remains in the concentrated composition after 4 weeks at 37° C. at a pH of 7. In at least one embodiment, at least 85%, at least 90%, at least 95%, at least 98%, or at least 99% of the peroxide remains after 4 weeks at 37° C. at a pH of 7.

The concentrated liquid composition may also comprise at least one other component chosen from surfactants, chelating agents, polymers, pH buffers, hydrotropes, organic solvents, fluorescent dyes, color dyes, perfumes, and combinations thereof.

Concentrated liquid compositions made in accordance with the present disclosure may be used to produce diluted cleaning compositions. In at least one embodiment, at least one enzyme may be added to a concentrated composition either before or after dilution.

Unless otherwise indicated, all percentages provided in the present disclosure and examples are by weight.

### EXAMPLES

### Comparative Examples 1-3 and Examples 4 to 6

### Organic Boron Compound Enzyme Stabilizers

Examples 1 to 3 in Table 1 test organic boron compounds known as typical enzyme stabilizers in a liquid cleaning composition without hydrogen peroxide. Examples 1 to 3 are comparative examples, and examples 4 to 6 include hydrogen peroxide.

TABLE 1
Enzyme stability impacted by organoboron compounds

| | Comp. | Comp. | Comp. | | | |
|---|---|---|---|---|---|---|
| Ingredient | Example 1 | Example 2 | Example 3 | Example 4 | Example 5 | Example 6 |
| Nonionic | 10% | 10% | 10% | 10% | 10% | 10% |
| surfactant | | | | | | |
| (AEO25-7) | | | | | | |
| Sodium | 5% | 5% | 5% | 5% | 5% | 5% |
| alkylbenzenesulfonate | | | | | | |
| Na₂SO₄ | 2% | 2% | 2% | 2% | 2% | 2% |
| H₂O₂ (PEROXAL | | | | 3% | 3% | 3% |
| 50 CG-HP)*¹ | | | | | | |
| Enzyme | 0.5% | 0.5% | 0.5% | 0.5% | 0.5% | 0.5% |
| (Savinase ® 16L) | | | | | | |
| Enzyme stabilizer | | 50 | | | 50 | |
| (4-FPBA*²): ppm | | | | | | |
| Enzyme stabilizer | | | 50 | | | 50 |
| (4-MOBA*³): | | | | | | |
| ppm | | | | | | |
| Water | to 100% | to 100% | to 100% | to 100% | to 100% | to 100% |
| pH (adjusted with | 7 | 7 | 7 | 7 | 7 | 7 |
| NaOH & H₂SO₄) | | | | | | |
| Residual enzyme | 63.81% | 95.68% | 78.07% | 0% | 0% | 0% |
| activity after 9 | | | | | | |
| days at 37° C. | | | | | | |

*¹PEROXAL 50 CG-HP is a commercial hydrogen peroxide containing peroxide stabilizers
*²4-FPBA: 4-Formylphenyl boronic acid
*³4-MOBA: 4-Methoxyphenyl boronic acid

Table 1 shows that the typical enzyme stabilizers of 4-FPBA and 4-MOBA stabilize, as expected, Savinase® 16L in the cleaning formulations without hydrogen peroxide. However, 4-FPBA or 4-MOBA doesn't stabilize Savinase® 16L when the cleaning formulation contains 3% hydrogen peroxide containing peroxide stabilizers. This means that not any known enzyme stabilizer working in a liquid formulation can work with the same efficacy in a liquid formulation with hydrogen peroxide.

### Comparative Example 7 and Examples 8 to 11

### Metal Ion Enzyme Stabilizers

Examples 7 to 11 tested the efficacy of metal ions (calcium, lithium, potassium, and sodium) as an enzyme stabilizer in a composition containing hydrogen peroxide and peroxide stabilizers. Examples 7 to 11 comprise PEROXAL 50 CLG, a commercial hydrogen peroxide (available from Arkema, Inc.) containing more than 100 ppm peroxide stabilizers.

TABLE 2
Enzyme stability improvement by metal ions

| | Comp. | | | | |
|---|---|---|---|---|---|
| | Exam- | Exam- | Exam- | Exam- | Exam- |
| Ingredient | ple 7 | ple 8 | ple 9 | ple 10 | ple 11 |
| Water | to 100% | to 100% | to 100% | to 100% | to 100% |
| Enzyme | 0.50% | 0.50% | 0.50% | 0.50% | 0.50% |
| (Savinase ® 16L) | | | | | |
| H₂O₂ | 1% | 1% | 1% | 1% | 1% |
| (PEROXAL | | | | | |
| 50 CLG) | | | | | |
| Enzyme stabilizer | | 400 | | | |
| (Ca²⁺): mM | | | | | |
| Enzyme stabilizer | | | 64 | | |
| (Li⁺): mM | | | | | |
| Enzyme stabilizer | | | | 20 | |
| (K⁺): mM | | | | | |
| Enzyme stabilizer | | | | | 200 |
| (Na⁺): mM | | | | | |
| pH (adjusted | 7 | 7 | 7 | 7 | 7 |
| with NaOH & | | | | | |
| H₂SO₄) | | | | | |
| Residual enzyme | <2% | 51% | 18% | 10% | 8% |
| activity after | | | | | |
| 4 weeks at 37° C. | | | | | |

Table 2 shows that all of the tested ions (Ca, Li, K, and Na) in Examples 8 to 11, compared to Example 7, which contained no enzyme stabilizer, were compatible in the compositions and decreased the decomposition rate of the enzyme. Calcium ions at a concentration of 400 mM maintained 51% of the residual enzyme activity after 4 weeks at 37° C.

### Comparative Example 12 and Examples 13 to 17

### Effect of Hydrogen Peroxide Stabilizer Concentration

Examples 12 to 17 were used to determine the effect of the concentration of the hydrogen peroxide stabilizer on compositions containing an enzyme and hydrogen peroxide. PEROXAL 50 CLG (available from Arkema, Inc.) is a commercially available hydrogen peroxide composition containing greater than 100 ppm of peroxide stabilizers. PEROXAL 50 EG (available from Arkema, Inc.) is a commercially available hydrogen peroxide composition containing less than 20 ppm of peroxide stabilizers.

TABLE 3
Enzyme and peroxygen stability improvement by Ca²⁺

| | Comp. | | | | | |
|---|---|---|---|---|---|---|
| | Example | Example | Example | Example | Example | Example |
| Ingredient | 12 | 13 | 14 | 15 | 16 | 17 |
| Water | to 100% | to 100% | to 100% | to 100% | to 100% | to 100% |
| Enzyme | 0.50% | 0.50% | 0.50% | 0.50% | 0.50% | 0.50% |
| (Savinase ® 16L) | | | | | | |
| H₂O₂ (PEROXAL | 1% | 1% | 1% | | | |
| 50 CLG) | | | | | | |
| H₂O₂ (PEROXAL | | | | 1% | 1% | 1% |
| 50 EG) | | | | | | |
| Enzyme stabilizer | | 100 | 200 | | 100 | 200 |
| (Ca²⁺): mM | | | | | | |
| pH (adjusted with | 7 | 7 | 7 | 7 | 7 | 7 |
| NaOH & H₂SO₄) | | | | | | |
| Residual enzyme | <2% | 38% | 40% | 2% | 18% | 24% |
| activity after 4 | | | | | | |
| weeks at 37° C. | | | | | | |
| Residual peroxide | 98.3% | 99.0% | 98.2% | 99.3% | 95.7% | 93.4% |
| content after 4 | | | | | | |
| weeks at 37° C. | | | | | | |

Table 3 shows in similar solutions with same levels of enzyme stabilizer, Ca ion, the enzyme in the solutions with more peroxide stabilizer (PEROXAL 50 CLG) is much more stable than in the solutions with lower amounts of peroxide stabilizers (PEROXAL 50 EG). Examples 12 & 13 show that addition of Ca ion stabilizes both Savinase® 16L and hydrogen peroxide.

### Examples 18 to 28

### Organic Enzyme Stabilizers

Examples 18 to 28 tested the effects of organic enzyme stabilizers in compositions containing enzyme, hydrogen peroxide and peroxide stabilizers. As shown in Table 4 below, the organic enzyme stabilizers present in Examples 19 to 28 exhibited improved residual enzyme activity compared to the control (Example 18), which did not contain an enzyme stabilizer. Examples 18 to 28 were prepared at pH 7.0 and contained 1% active PEROXAL 50 CLG (Arkema, Inc.), 0.5% Savinase® 16L, and 5% enzyme stabilizers.

TABLE 4
Enzyme and hydrogen peroxide stability in accelerated tests.

| | | 4 Weeks at 37° C. | |
|---|---|---|---|
| | | Residual | Residual |
| | | enzyme | peroxide |
| Example | Enzyme Stabilizer | activity | content |
| 18 | None (control) | 5.3 ± 2.3% | 98.8 ± 0.1% |
| 19 | Ethylene glycol | 9.20% | 99.9 ± 2.1% |
| 20 | Erythritol | 11.0 ± 0.9% | 99.3 ± 0.0% |
| 21 | Xylitol | 10.3 ± 0.4% | 99.4 ± 0.5% |
| 22 | Galactitol | 11.2 ± 1.8% | 100.4 ± 0.2% |
| 23 | Maltitol | 7.2 ± 2.7% | 100.4 ± 1.3% |
| 24 | Inositol | 11.2 ± 2.4% | 99.8 ± 0.1% |
| 25 | Sorbitol | 8.8 ± 2.6% | 100.7 ± 1.4% |
| 26 | Mannitol | 8.4 ± 1.1% | 100.4 ± 0.3% |
| 27 | 1,6-Hexanediol | 0.6 ± 0.3% | 99.4 ± 2.4% |
| 28 | Triethanolamine | <1% | 82.1 ± 1.1% |

Table 4 shows that ethylene glycol and the sugar alcohols (erythritol, xylitol, galactitol, maltitol, inositol, sorbitol, mannitol) resulted in stabilized solutions. Triethanolamine resulted in a decrease in the residual enzyme activity and residual peroxide content with respect to the control (Example 18), and 1,6-hexanediol stabilized the peroxide but not the enzyme.

### Examples 29 to 37

### Metal Ion Enzyme Stabilizers

Examples 29 to 37 studied the effect of various metal ion enzyme stabilizers in compositions comprising 1% active PEROXAL 50 CLG (Arkema, Inc.) and 0.5% Savinase® 16L at pH 7.0.

TABLE 5
Enzyme and hydrogen peroxide stability with metal additives.

| | | 4 weeks at 37° C. | |
|---|---|---|---|
| | | Residual | Residual |
| | | enzyme | peroxide |
| Example | Enzyme Stabilizer | activity | content |
| 29 | None (control) | 2.0% | 94.6 ± 0.6% |
| 30 | 0.4% calcium nitrate | 17.7 ± 2.6% | 99.9 ± 0.1% |
| 31 | 0.8% calcium nitrate | 31.1 ± 3.5% | 99.7 ± 0.6% |
| 32 | 1.6% calcium nitrate | 37.5 ± 0.8% | 99.0 ± 0.5% |
| 33 | 3.2% calcium nitrate | 39.7 ± 0.6% | 98.2 ± 0.1% |
| 34 | 0.17% lithium sulfate | 14.2 ± 1.0% | 96.4 ± 0.7% |
| 35 | 0.35% lithium sulfate | 17.9 ± 2.5% | 95.5 ± 0.7% |
| 36 | 0.17% potassium sulfate | 10.3 ± 0.3% | 98.4 ± 0.6% |
| 37 | 1.4% sodium sulfate | 8.3 ± 4.3% | 92.5 ± 4.4% |

As shown in Table 5, increasing amounts of metal additives generally improved the stability of the compositions. As the amount of calcium nitrate increased in Examples 30 to 33, the residual enzyme activity also increased.

### Examples 38 to 42

### Destabilizing Metal Additives

Examples 38 to 42 studied the effect of zinc sulfate and aluminum sulfate in compositions comprising 1% active PEROXAL 50 CLG (Arkema, Inc.) and 0.5% Savinase® 16L at pH 7.0. Zinc sulfate is a known enzyme stabilizers. However, as shown in Table 6, zinc sulfate and aluminum sulfate have a destabilizing effect on the activity of the enzyme.

TABLE 6
Enzyme destabilizing metal additives.

| | | Residual Enzyme Activity |
|---|---|---|
| Example | Enzyme Stabilizer | 2 weeks at 37° C. |
| 38 | None (control) | 39.1% |
| 39 | 8 ppm zinc sulfate | 25.1% |
| 40 | 80 ppm zinc sulfate | 8.9% |
| 41 | 7 ppm aluminum sulfate | 23.4% |
| 42 | 70 ppm aluminum sulfate | 3.2% |

### Examples 43 to 52

### Stabilizer Combinations

Examples 43 to 52 studied the effects of multiple stabilizers in compositions comprising 1% active PEROXAL 50 CLG (Arkema, Inc.) and 0.5% Savinase® 16L at pH 7.0.

TABLE 7
Enzyme and hydrogen peroxide with stabilizer combinations.

| | | 4 weeks at 37° C. | |
|---|---|---|---|
| | | Residual | Residual |
| | | enzyme | peroxide |
| Example | Enzyme Stabilizer | activity | content |
| 43 | None (control) | 2.0% | 94.6 ± 0.6% |
| 44 | 0.4% calcium nitrate | 17.7 ± 2.6% | 99.9 ± 0.1% |
| 45 | 0.4% calcium nitrate | 29.6 ± 5.3% | 99.1 ± 0.3% |
| | 0.35% lithium sulfate | | |
| | 5% sorbitol | | |
| 46 | 0.4% calcium nitrate | 33.0% | 98.9 ± 0.7% |
| | 0.35% lithium sulfate | | |
| | 5% xylitol | | |
| 47 | 0.4% calcium nitrate | 21.9 ± 2.2% | 99.7 ± 0.2% |
| | 5% ethylene glycol | | |
| | 5% sorbitol | | |
| 48 | 0.4% calcium nitrate | 24.1 ± 3.3% | 99.5 ± 1.1% |
| | 5% ethylene glycol | | |
| | 5% xylitol | | |
| 49 | 0.8% calcium nitrate | 31.1 ± 3.5% | 99.7 ± 0.6% |
| 50 | 0.8% calcium nitrate | 43.7 ± 2.2% | 98.2 ± 0.1% |
| | 0.35% lithium sulfate | | |
| 51 | 0.8% calcium nitrate | 44.1 ± 0.7% | 97.5 ± 1.9% |
| | 0.35% lithium sulfate | | |
| | 5% sorbitol | | |
| 52 | 0.8% calcium nitrate | 18.8 ± 0.6% | 99.9 ± 0.5% |
| | 5% ethylene glycol | | |
| | 5% sorbitol | | |

As shown in Table 7, compatibilizer packages comprising a combination of a metal additive and organic additives generally exhibited an improved residual enzyme activity compared to using a metal additive alone.

### Examples 53 and 54

### Anionic Polymer Enzyme Stabilizer

Examples 53 and 54 studied the effect of an anionic polymer stabilizer, Acusol® 425N in compositions comprising 1% active PEROXAL 50 CLG and 0.5% Savinase® 16L at pH 7.0. As shown in Table 8, the anionic polymer exhibited an improved residual enzyme activity compared to a control using no enzyme stabilizer.

TABLE 8
Enzyme and hydrogen peroxide stability
with anionic polymer enzyme stabilizer.

4 weeks at 37° C.

| | | Residual | Residual |
|---|---|---|---|
| | | enzyme | peroxide |
| Example | Enzyme Stabilizer | activity | content |
| 53 | None (control) | <1% | 98.8 ± 0.1% |
| 54 | 2% Acusol ® 425N | 11.2% | 96.7 ± 0.8% |

### Examples 55-59

### Neutral and Cationic Polymer Enzyme Stabilizers

Examples 55-59 studied the effect of neutral and cationic polymer enzyme stabilizers in compositions comprising 1% active PEROXAL 50 CLG and 0.5% Everlase® 16L at pH 7.0. As shown in Table 9, the polymer enzyme stabilizers exhibited an improved residual enzyme activity and residual peroxide content compared to a control using no enzyme stabilizer.

TABLE 9
Enzyme and hydrogen peroxide stability with neutral
or cationic polymer enzyme stabilizers.

| | | 4 weeks at 37° C. | |
|---|---|---|---|
| | | Residual | Residual |
| | | enzyme | peroxide |
| Example | Enzyme Stabilizer | activity | content |
| 55 | None (control) | <1% | 98% |
| 56 | 0.2% Pluronic ® 25R2 | 19.8 ± 4.3% | 99.9 ± 0.4% |
| 57 | 0.2% PEG-40 stearate | 16.2 ± 1.3% | 99.4 ± 0.7% |
| 58 | 0.2% Luviquat ® EC 370 | 32.2 ± 1.9% | 100.4 ± 0.1% |
| 59 | 0.2% Luviquate ® PQ 11 | 39.9 ± 11.2% | 99.7 ± 0.1% |

### Examples 60-63

### Small Molecule Enzyme Stabilizers

Examples 60-63 studied the effect of small molecule enzyme stabilizers in compositions comprising 1% active PEROXAL 50 CLG and 0.5% Everlase® 16L at pH 7.0. As shown in Table 10, the enzyme stabilizers exhibited an improved residual enzyme activity compared to a control using no enzyme stabilizer.

TABLE 10
Enzyme and hydrogen peroxide stability
with small molecule enzyme stabilizers.

| | | 4 weeks at 37° C. | |
|---|---|---|---|
| | | Residual | Residual |
| | | enzyme | peroxide |
| Example | Enzyme Stabilizer | activity | content |
| 60 | None (control) | <1% | 98% |
| 61 | 1% trifluoroacetic acid | 40.1 ± 3.8% | 98.1 ± 0.3% |
| 62 | 1% dimethyl sulfone | 13.8 ± 1.2% | 98.0 ± 0.4% |
| 63 | 1% sulfolane | 10.9 ± 4.0% | 97.4 ± 1.3% |

### Examples 64 and 65

### Carboxylate Enzyme Stabilizer

Examples 64 and 65 studied the effect of a carboxylate enzyme stabilizer, sodium salicylate, in compositions comprising 1% active PEROXAL 50 CLG and 0.5% Everlase® 16L at pH 7.0. As shown in Table 11, the carboxylate enzyme stabilizers exhibited an improved residual enzyme activity and residual peroxide content compared to a control using no enzyme stabilizer.

TABLE 11
Enzyme and hydrogen peroxide stability
with carboxylate enzyme stabilizers.

| | | 4 weeks at 37° C. | |
|---|---|---|---|
| | | Residual | Residual |
| | | enzyme | peroxide |
| Example | Enzyme Stabilizer | activity | content |
| 64 | None (control) | <1% | 98% |
| 65 | 0.17% sodium salicylate | 26.0 ± 7.8% | 99.0 ± 0.6% |

1. An aqueous, liquid composition comprising:
at least one enzyme;
at least one peroxide or peroxide source; and
a compatibilizer package, wherein the compatibilizer package comprises at least one compound chosen from enzyme stabilizers and peroxide stabilizers, and the compatibilizer package stabilizes the at least one enzyme and the at least one peroxide or peroxide source.

2. The composition of claim 1, wherein the at least one enzyme is present in an amount ranging from about 0.001% to about 10% by weight of the composition and the at least one hydrogen peroxide or hydrogen peroxide source is present in an amount ranging from about 1 ppm to about 10% by weight of the composition.

3. The composition of claim 1, wherein the compatibilizer package comprises at least one enzyme stabilizer chosen from:
diols;
polyols;
short carbon chain fatty acids;
amines;
alkanolamines;
compounds comprising calcium, magnesium, sodium, potassium, lithium, tin, organic ammonium ions, and combinations thereof;
ligands of formula XY₂Rₙ, wherein X is chosen from boron, carbon, nitrogen, silicon, phosphorus, and sulfur atoms, Y is chosen from hydroxyl groups, oxygen atoms, and halogen atoms, and R is independently chosen from hydroxyl groups, alkyl groups containing 1 to 12 carbon atoms, aryl groups containing 1 to 12 carbon atoms, hydrogen atoms, oxygen atoms, and halogen atoms, and n is 1 to 4;
cationic, anionic, zwitterionic, or neutral polymers; and
carboxylic acids or carboxylate salts comprising an aliphatic chain of 12 carbon atoms or less or an aromatic group; and
combinations thereof.

4. The composition of claim 3, wherein the at least one enzyme stabilizer is present in an amount ranging from about 10 ppm to about 25% by weight of the composition.

5. The composition of claim 3, wherein the at least one enzyme stabilizer comprises a polyol containing 2 to 12 hydroxyl groups and 2 to 12 carbon atoms.

6. The composition of claim 3, wherein the at least one enzyme stabilizer comprises a diol containing 2 to 10 carbon atoms.

7. The composition of claim 1, wherein the compatibilizer package comprises at least one enzyme stabilizer chosen from ethylene glycol, erythritol, xylitol, galactitol, maltitol, inositol, sorbitol, mannitol, and combinations thereof.

8. The composition of claim 3, wherein the compatibilizer package comprises at least one ligand of formula XY₂Rₙ, wherein X is a carbon, nitrogen, or sulfur atom, Y is a halogen or oxygen atom, R is independently chosen from hydroxyl groups, alkyl groups containing 1 to 12 carbon atoms, aryl groups containing 1 to 12 carbon atoms, hydrogen atoms, oxygen atoms, and halogen atoms, and n is 1 to 4.

9. The composition of claim 3, wherein the compatibilizer package comprises at least one ligand of formula XY₂Rₙ, wherein X is a boron, silicon, or phosphorus atom, Y is a hydroxyl group, R is independently chosen from hydroxyl groups, alkyl groups containing 1 to 12 carbon atoms, aryl groups containing 1 to 12 carbon atoms, hydrogen atoms, oxygen atoms, and halogen atoms, and a is 1 or 2

10. The composition of claim 1, wherein the compatibilizer package comprises an enzyme stabilizer chosen from trifluoroacetic acid, dichloroacetic acid, 2-chloro-2-fluorobutane, 2,2,2-trifluoroacetophenone, hexafluoroacetone, dimethyl sulfone, sulfolane, 4-formylphenylboronic acid, diphenylsilanediol, methylphosphonic acid, phenylphosphonic acid, acetic acid, benzoic acid, picolinic acid, salicylic acid, sodium salicylate, and combinations thereof.

11. The composition of claim 3, wherein the compatibilizer package comprises a polymer chosen from polyacrylates, polymethacrylates, polyacrylamide, polyquaterniums, polyoxypropylene-polyoxyethylene block copolymers, polyethylene glycols, polyacrylates, and polybetaines.

12. The composition of claim 1, wherein the compatibilizer package comprises at least one peroxide stabilizer chosen from stannates, organic chelating agents, and combinations thereof.

13. The composition of claim 1, wherein the compatibilizer package comprises at least one peroxide stabilizer chosen from polyols, diols, carboxylates, phosphates, pyrophosphates, stannates, ethylenediaminetetraacetic acid (EDTA), amine-substituted organophosphonic acids or their salts, butylated hydroxytoluene (BHT), butylated hydroxyanisole (BHA), phenols, and combinations thereof.

14. The composition of claim 1, wherein the at least one enzyme is chosen from proteases, amylases, lipases, cellulases, pectinases, lyases, disinfectant enzymes, and combinations thereof.

15. The composition of claim 14, wherein the at least one enzyme is chosen from chitinase, chitosanase, N-acetylmuramidase, N-acetylglucoasiminidase, actinase, zymolyase, kitalase, mutanolysin, achromopeptidase, beta-1,3-glucanase, and combinations thereof.

16. The composition of claim 1, wherein the compatibilizer package comprises at least one enzyme stabilizer and at least one peroxide stabilizer.

17. The composition of claim 1, wherein the at least one peroxide or peroxide source is chosen from hydrogen peroxide, peroxy acids, and alkylhydroperoxides.

18. The composition of claim 1, wherein at least 10% of the enzyme activity remains after 4 weeks at 37° C. at a pH of 7.

19. The composition of claim 1, wherein at least 90% of the hydrogen peroxide remains after 4 weeks at 37° C. at a pH of 7.

20. A cleaning composition comprising the composition of claim 1, wherein the cleaning composition is formulated for laundry detergent, fabric softener, laundry prespotter, auxiliary bleach, hand dish detergent, automatic dishwasher detergent, carpet prespotter, carpet cleaner, hard surface cleaner, toilet bowl cleaner, hand detergent, general basin/tub/tile foam cleaner, abrasive surface cleaner, or disinfection use.

21. An aqueous, liquid composition comprising:
at least one peroxide or peroxide source; and
a compatibilizer package,
wherein the compatibilizer package comprises at least compound chosen from enzyme stabilizers and peroxide stabilizers, and
wherein the at least one peroxide or peroxide source is present in an amount of 10% by weight or more based on the total weight of the composition.

22. The composition according to claim 21, wherein the compatibilizer package comprises at least one enzyme stabilizer chosen from diols, polyols, short carbon chain fatty acids, amines, ethanolamines, and compounds comprising calcium, magnesium, sodium, potassium, lithium, tin, barium, organic ammonium ions, and combinations thereof.

23. The composition according to claim 21, wherein the compatibilizer package comprises at least one peroxide stabilizer chosen from polyols, diols, phosphates, pyrophosphates, carboxylates, stannates, ethylenediaminetetraacetic acid (EDTA), amine-substituted organophosphonic acid or their salts, butylated hydroxytoluene (BHT), butylated hydroxyanisole (BHA), phenols, and combinations thereof.

24. The composition according to claim 21, wherein at least 90% of the hydrogen peroxide or hydrogen peroxide source remains after 4 weeks at 37° C. at a pH of 7.
